(19) United States
(12) Patent Application Publication
(10) Pub. No.: US 2007/0137879 A1
(43) Pub. Date: Jun. 21, 2007

(54) Three-dimensional flat cable

(75) Inventors: Denis Reibel, Herrlisheim (FR); Thorsten Frank, Heidelberg (DE)

Correspondence Address: GROSSMAN, TUCKER, PERREAULT & PFLEGER, PLLC, 55 SOUTH COMMERICAL STREET, MANCHESTER, NH, 03101, US

(73) Assignee: CARL FREUDENBERG KG, Weinhein (DE)

(21) Appl. No.: 10/598,059

(22) PCT Filed: Jan. 22, 2005
(86) PCT No.: PCT/EP05/00621

§ 371 Date: Aug. 16, 2006

(30) Foreign Application Priority Data
Feb. 17, 2004 (DE) 10 2004 007 875.0

(51) Int. Cl. H01B 7/08

(52) U.S. Cl. 174/117 FF

(57) ABSTRACT

The invention relates to a three-dimensional flat cable, to a method for the production thereof and to the use thereof. Said flat cable is made of a laminate which comprises at least one conductor path, which is bonded between two insulation layers, and at least one support layer, said layer being connected to each other by means of an adhesive layer. The laminate is placed on a positive forming tool and brought into shape by the application of heat, radiation and/or pressure, and fixed in the three-dimensional shape thereof by cooling to below the glass temperature T_{g}, of the adhesive layer and/or by reactive hardening of the adhesive layer.

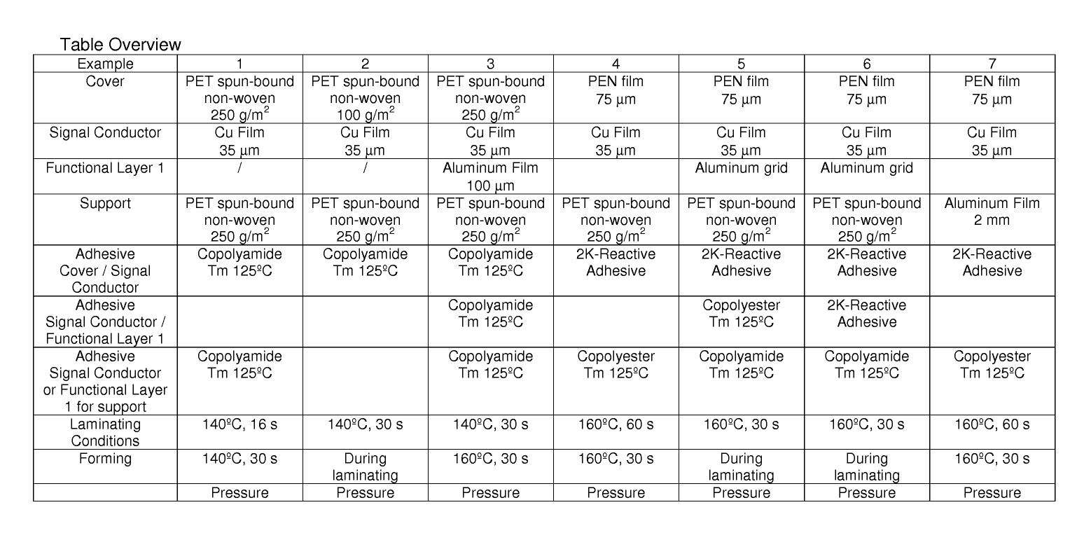

The invention relates to a three-dimensional (3D) flat cable.

Document DE-A 196 49 972 describes a method for producing a cable tree for vehicles in which the cable leads adhere to a carrier film and are provided with plugs and are fitted to a stable carrier, wherein at least some of the cable wires are made of un-insulated filament wires, which are placed successively and independently of each other on an insulating carrier foil comprising an adhesive layer in a required layout and subsequently an insulating protective layer is placed on the carrier foil and glued to the carrier foil by applying pressure or the carrier foil and the filament wires placed thereon are covered with a protective lacquer coating and subsequently adapted to the contour of the installation area by cutting. The disadvantage with this method is the complex wiring of the conductor paths and the fixation thereof to the stable carrier.

From document DE-A 196 28 850 a wire harness and a method for the production thereof are known, which harness comprises power cords, which are disposed in a first resin layer with recesses, wherein the first resin layer is shaped such that it extends along a predetermined path of the power cords, and a second resin layer, which is firmly connected to the first resin layer, so that it covers at least the recess of the first resin layer and is provided by vacuum-molding.

The known solutions have the disadvantage that they are either have to be produced in a very complex manual process on the surface of a dimensionally stable carrier or that separate parts are produced, and the conductors are then introduced and have to be fixed in position by the second resin.

The object of the invention is to provide a three-dimensional flat cable as well as a method for the production thereof, which cable and method avoid the disadvantages associated with the familiar solutions and which in the intermediate step allow the production of dimensionally stable flat cables, which only have to be fixed in place at the installation site in a second step.

According to the invention, the object is achieved with a flat cable made of a laminate, which comprises a conductor layer that is bonded between at least one cover layer and at least one support layer, the layers being mutually connected by means of an adhesive layer, and the cable being placed on a positive forming tool and brought into the three-dimensional shape by the application of heat and pressure as well as by cooling to below the glass temperature T_{g} of the adhesive layer or by reactive curing of the adhesive layer. A 3D flat cable of this type can also be stored as an intermediate part prior to installation. The support layer may be made of metal or plastic film, a flat material made of a fabric of plastic or glass fibers, or a porous layer. The films in this case are those with a layer thickness ranging from about 0.010 to 2 mm.

It is preferred if a thermoplastic adhesive, a thermoplastic adhesive film or an adhesive non-woven fabric with a melting point Tₘ of <210° C. and/or a latent reactive adhesive with a cross-linking temperature of <210° C. is used as the adhesive layer. Adhesive layers of this type allow it to firmly bond the flat cable to the support layer and form an intermediate part.

For better handling, furthermore a further porous layer serving as cover may be provided. The porous layer is advantageously made of a non-woven fabric or a fabric made of polymer fibers.

In a particularly preferred embodiment a cover layer is a non-woven fabric layer, which comprises only polyester, polyamide, polyolefin, syndiotactic polystyrene, polysulfone and/or glass fibers and the pores of which are filled between the fibers or filaments so strongly with a binding agent that a dielectric strength of at least 500 V [is achieved].

The flat cable according to the invention may be at least back-injected using a thermoplastic. This enables the production of parts that are designed with the installation site in mind.

Advantageously, the conductors of the conductor path are exposed prior to laminating at least in partial regions of their surfaces so as to form contact fields.

A flat cable that is provided with electronic components is particularly preferred. This way, finished electronic mounting parts can be produced very efficiently.

The production of the 3D flat cables as intermediate parts is carried out such that the laminate comprising a conductor layer that is integrated at least between cover, adhesive and support layers is placed on a positive forming tool, aligned, and brought into shape by the application of heat, radiation and/or pressure as well as fixed in its shape by cooling the adhesive layer to below the glass temperature T_{g} or by hardening the adhesive layer. The pressure that is applied is, for example, a vacuum that is applied to the back of the laminate.

The laminate parts that have been fixed in their shapes are preferably processed by blanking, milling or cutting and installed, in a separate step, at the installation site or back-injected with a thermoplastic at least in some regions using an injection molding process to allow easier assembly.

So as to balance the temperature, is it preferred if a metal film, grid or net is used during the lamination process and/or in the forming tool.

The laminate parts can be pressed at least in a partial region against the wall of the forming tool by the thermoplastics acting upon the part surface as the injection molding process is carried out and can be fixed in their shape. This simplifies the fixing of the shape considerably.

The non-woven fabrics that are used for the method are preferably made of polyester or polyamide, having a thickness of 0.1 to 2 mm, ultimate tensile strength of 50 to 250 N/50 mm and expansion of 30 to 50%. The adhesive non-woven fabric used as the adhesive layer should have a softening temperature between 120 and 210° C., the basis weight should range between 36 and 600 g/m², depending on the desired dimensional stability, and it should have a low melt-flow index.

The invention will be explained hereinafter with reference to the examples.

### EXAMPLE 1

A flexible, three-dimensional flat cable, comprising two polyethylene terephthalate (PET) spun-bound non-wovens, is produced by laminating between the spun-bound non-woverns the electric signal conductors with a thickness of 35 μm, the signal conductors being disposed at a distance of 2.54 from each other, with the aid of a copolyamide adhesive at 140° C. This laminate is fixed on a positive forming tool while applying heat and pressure. After cooling, the laminate is removed as a flat cable. The properties of the components that are used are summarized in Table 1.

### EXAMPLE 2

A flexible, three-dimensional flat cable, comprising two PET spun-bound non-wovens, is produced by laminating between the spun-bound non-wovens the electric signal conductors with a thickness of 35 mm, the signal conductors being disposed at a distance of 2.54 from each other, with the aid of a copolyamide adhesive at 140° C. using a positive forming tool. After cooling, the laminate is removed as a flat cable. The properties of the components that are used are summarized in Table 1.

### EXAMPLE 3

A flexible, three-dimensional flat cable, comprising a PET spun-bound non-woven as the cover layer, a PET spun-bound non-woven as the support layer and a 100 μm aluminum film as the heat distribution layer, is produced by laminating the electric signal conductors with a thickness of 35 μm. The adhesive layers between the cover fabric and the signal conductors, which are preferably made of copper, as well as between the signal conductors and the aluminum film, as well as between the aluminum film and the support fabric are copolyamides with a melting point of 125° C. The finished laminate is fixed on a positive forming tool and brought into shape at 160° C. for 30 seconds. After cooling, the laminate is removed as a flat cable. The properties of the components that are used are summarized in Table 1.

### EXAMPLE 4

A flexible, three-dimensional flat cable, comprising a polyethylene naphthalate (PEN) cover film and a PET spun-bound non-woven as the support layer, is produced by laminating between the two layers the electric signal conductors with a thickness of 35 mm. The adhesive layer between the cover film and the signal conductors made of copper film is a 2K reactive adhesive system on polyester polyurethane (PES-PU) basis. The adhesive layer between the copper film and the spun-bound non-woven is a copolyester with a melting point of 135° C. The finished laminate is fixed on a positive forming tool and brought into shape at 160° C. for 30 seconds. After cooling, the laminate is removed as a flat cable. The properties of the components that are used are summarized in Table 1.

### EXAMPLE 5

A flexible, three-dimensional flat cable, comprising a PEN cover film and a PET spun-bound non-woven as the support layer, is produced by laminating the electric signal conductors with a thickness of 35 μm between the two layers. The adhesive layer between the cover film and the copper film is a 2K reactive adhesive system on PES-PU basis. The adhesive layer between the Cu film and the spun-bound non-woven is a copolyester with a melting point of 135° C. The lamination step is carried out on a positive forming tool at 160° C. After cooling, the laminate is removed as a flat cable. The properties of the components that are used are summarized in Table 1.

### EXAMPLE 6

A flexible, three-dimensional flat cable, comprising a PET cover film, a PET spun-bound non-woven as the support layer, and an aluminum net or the like as a heat distribution layer, is produced by laminating the electric signal conductors with a thickness of 35 μm between the two electrically insulating layers. A 2K reactive adhesive system on PES-PU basis is used as the adhesive layers between the cover film and the signal conductor as well as between the signal conductor and the heat distribution layer. The adhesive layer between the aluminum film and the spun-bound non-woven is a copolyamide with a melting point of 125° C. The lamination step is carried out on a positive forming tool at 160° C. After cooling, the laminate is removed as a flat cable. The properties of the components that are used are summarized in Table 1.

### EXAMPLE 7

A flexible, three-dimensional flat cable, comprising a PEN cover film and a 2 mm thick aluminum film as the support layer, is produced by laminating the electric signal conductors (Cu) with a thickness of 35 μm between the two layers. The adhesive layer between the cover film and the copper film is a 2K reactive adhesive system on PES-PU basis. The adhesive layer between the copper film and the aluminum film is a copolyester with a melting point of 135° C. The finished laminate is fixed on a positive forming tool and brought into shape at 160° C. for 30 seconds. After cooling, the laminate is removed as a flat cable. The properties of the components that are used are summarized in Table 1.

1. A three-dimensional flat cable made of a laminate, which comprises at least one conductor path, which is bonded between at least one cover layer and at least one support layer, wherein at least one adhesive layer is provided for bonding the layers, which layer following or during a forming process of the laminate fixes the flat cable in the three-dimensional shape by the application of heat, radiation and/or pressure.

2. A flat cable according to claim 1, characterized in that the support layer is made of a metal or plastic film, a metal or plastic grid or of a similar flat material made of a textile with carbon fibers or glass fibers.

3. A flat cable according to claim 1, characterized in that the support layer is a porous layer.

4. A flat cable according to claim 1, characterized in that the adhesive layer is made of a thermoplastic adhesive, an adhesive film and/or an adhesive non-woven fabric with a melting point Tₘ of <210° C. and/or a latent reactive adhesive with a cross-linking temperature of <210° C.

5. A flat cable according to claim 3, characterized in that at least one further porous layer is provided to serve as a cover.

6. A flat cable according to claim 5, characterized in that the porous layer is made of a non-woven fabric or a non-woven with polymer fibers.

7. A flat cable according to claim 1, characterized in that the cover layer is a non-woven fabric layer, which comprises only polyester, polyamide, polyolefin, syndiotactic polystyrene, polysulfone, carbon and/or glass fibers and the pores of which are filled between the fibers or filaments so strongly with a binding agent that a dielectric strength of at least 500 V is achieved.

8. A flat cable according to claim 1, characterized in that the flat cable is back-injected at least in some regions with a thermoplastic or an elastomer.

9. A flat cable according to claim 1, characterized in that the conductors of the conductor path are exposed at least in some regions of the surface prior to the laminating process so as to form contact fields.

10. A flat cable according to claim 1, characterized in that the flat cable is provided with electronic elements.
